(19) United States
(12) Patent Application Publication
(10) Pub. No.: US 2007/0240126 A1
(43) Pub. Date: Oct. 11, 2007

(54) System and method for event based resource selection

(75) Inventor: Stevan C. Allen, Gilroy, CA (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/345,804

(22) Filed: Feb. 1, 2006

(51) Int. Cl. G06F 9/44

(52) U.S. Cl. 717/130

(57) ABSTRACT

Embodiments of the present invention are directed to systems and methods for managing a plurality of computer resources, such as networked storage devices. Each of the plurality of resources may have different characteristics, such as performance and/or requirement parameters. Embodiments of the present invention allow an administrator to assign the selection prioritization based on the particular event being processed, such as a network broadcast or e-mail. A weighting function based on the particular event may be defined in a policy and applied to the individual characteristics, e.g. speed and security, of each resource. The available resources are then ranked according to the output of the weighting function and the highest ranking available resource is then selected. Thus, the most appropriate resource is selected based upon the individual identified characteristics of the available resources optimized by the weighted requirements specified in the policy for the particular event.

### BACKGROUND OF THE INVENTION

1. Field of the Invention

The present invention relates to management and selection of a resource such as a device or data path within a group of dissimilar resources. Particularly, the present invention relates to automated data storage system space allocation within a data processing system utilizing a dynamic set of prioritized data set parameters.

2. Description of the Related Art

Computer systems employing a plurality of connected resources, such as a plurality of storage devices in a networked storage system, may employ different systems and methods for the management of those resources. For example, when storage is requested by a user, the system may determine which storage device is most appropriate before delivering storage access to the user. Various systems and methods have been developed to facilitate the selection and management of such resources available to users in a networked computer system.

A job control language (JCL) has been utilized by computer systems which required the computer user to specify many parameters of program execution, including specifications for peripheral data storage. Thus, each time the peripheral data storage was changed, a corresponding change was required in the JCL statements for the programs to be executed. One example of JCL control of a data processor is shown in U.S. Pat. No. 4,104,718, issued Aug. 1, 1978 to Pobulan et al. This express interaction between the operation of a peripheral data storage system and user application programs represents an increasingly difficult task for computer programs due to the immensity of storage capacity which is available in modern information processing systems.

Accordingly, it is desirable to allow a user or application programmer to specify program execution and data storage requirements at a logical level. It is also desirable that all allocation and controls for peripheral data storage be removed from direct intervention by the application programmer. One example of an application of the logical level control of storage devices is illustrated in U.S. Pat. No. 4,403,288, issued Sep. 6, 1983 to Christian et al., wherein one physical device is addressable as four separate logical devices.

The proliferation of direct access storage devices (DASD) within peripheral data storage subsystems has resulted in a centralized DASD storage space allocation program known as direct access device space management (DADSM). However, the application programmer still must request storage space in terms of device parameters and types. One example of this technology may be seen in “Asynchronous Allocation Requests” Duvall et al., IBM Technical Disclosure Bulletin, Volume 235, No. 8, January 1983, pp. 4148-4150.

A virtual data storage system which employs a memory control processor which is external to the host processor that divides user-defined data sets into blocks of a convenient size for storage in peripheral data storage devices is illustrated in U.S. Pat. No. 4,467,421, issued Aug. 21, 1984 to White. The system utilizes a memory processor to assign these blocks to storage locations on peripheral data storage devices. The memory processor intercepts the device oriented input/output commands from the host processor and adjusts operation of the peripheral data storage system to make it more efficient. This system still requires the application programmer to utilize JCL statements that are device dependent, even if an external memory processor interprets the device dependencies differently than intended by the application programming. While this arrangement may ease the affects of changing device types and the like, it still burdens the application programmer device parameter considerations.

U.S. Pat. No. 4,638,425, issued Jan. 20, 1987 to Hartung, shows a cached direct access storage device (DASD) subsystem in which the application programmer may insert a storage parameter indication of whether certain data records may be stored primarily within volatile peripheral storage, or primarily retentively stored within direct access storage devices within the peripheral system. When stored primarily within cache, performance is enhanced; however, the application program is responsible for any lost data due to power problems or equipment failures. While the use indication provided within this system appears to operate on a relatively high logical level, it may be seen that the application programmer still is required to understand important operational characteristics of the peripheral data storage system.

U.S. Pat. No. 4,607,346, issued Aug. 19, 1986 to Hill, teaches an implicit control of a peripheral DASD based upon the user or application programmer specifying “access densities” for a given program. Based upon such specified access densities, the data to be stored is directed to different portions of a DASD. From this description it may be seen that the application programmer must still be involved with the device parameters; however, the device parameter designations are complicated with the desired access parameters of the application program.

U.S. Pat. No. 4,528,624, issued Jul. 9, 1985 to Kamionka et al., teaches the selection of peripheral devices for allocations prepatory to peripheral data storage based upon maximum free storage space within each device. This selection is independent of the actual storage capacity of the various devices. This is a simple but relatively effective selection process which may be machine executed after the application programmer has completed the device related JCL statement; i.e., the machine operations for data space allocations do not alleviate all of the interactions between the application programmer and device characteristics.

U.S. Pat. No. 5,018,060, issued May 21, 1991 to Gelb et al., teaches a technique whereby data storage space may be allocated within peripheral data storage devices utilizing implied allocation based upon user specified parameters. A plurality of data classes, storage classes and management classes are specified which each define predetermined characteristics of diverse units of data, predetermined sets of storage performance and availability requirements and life cycle attributes for units of data. A plurality of storage groups which each define diverse predetermined performance device and management characteristics within the data storage subsystem are also defined. Each received space allocation request is then matched utilizing these parameters with the data, storage, and management classes for assignment to one of each of those classes to the unit of data related to the allocation request.

While the system of U.S. Pat. No. 5,018,060 represents a substantial advance in the automation of data storage system space allocation, a storage device may be selected for utilization without regard to multiple parameters which may be associated with data classes unless each such parameter is satisfied. Failing to satisfy one or more parameters associated with the data will result in the assignment of that data to a device within a storage group merely based upon the availability of space within that device.

U.S. Pat. No. 5,491,810, issued Feb. 13, 1996 to Allen, discloses a method and system for automatically allocating space within a data storage system for multiple data sets which may include units of data, databases, files or objects. Each data set preferably includes a group of associated preference/requirement parameters which are arranged in a hierarchical order and then compared to corresponding data storage system characteristics for available devices. The data set preference/requirement parameters may include performance, size, availability, location, portability, share status and other attributes which affect data storage system selection. Data storage systems may include solid-state memory, disk drives, tape drives, and other peripheral storage systems. Data storage system characteristics may thus represent available space, cache, performance, portability, volatility, location, cost, fragmentation, and other characteristics which address user needs. The data set preference/requirement parameter hierarchy is established for each data set, listing each parameter from a “most important” parameter to a “least important” parameter. Each attempted storage of a data set will result in an analysis of all available data storage systems and the creation of a linked chain of available data storage systems representing an ordered sequence of preferred data storage systems. Data storage system selection is then performed utilizing this preference chain, which includes all candidate storage systems.

U.S. Pat. No. 6,934,800, issued Aug. 23, 2005 to Allen et al., discloses a computer system that includes a computer and a storage system. The storage system includes a plurality of storage resources, each of which includes one or more storage volumes. Data sets are allocated among the storage volumes according to a policy of requirements and preferences based on separation of critical data sets so that a single point of failure in one storage resource will have minimal impact on data sets stored in a different resource. According to the method, a second currently stored data set to be separated from a new first data set is identified. A storage resource and any volume thereof that contains the second data set is identified. An eligible volume list for selection of a storage volume for the first data set is formed according to the policy. The storage volumes of the storage resource identified as containing the second data set are excluded from the eligible volume list. The storage volumes of the remaining storage resources are ordered according to a preference level of storage resources.

In prior art systems, when a method is needed to select between resources of a data storage system each having different characteristics, e.g. performance and/or requirement parameters, a separate resource preference policy is typically defined for each event. For example, a resource characteristic may be speed, security, reliability, or any other relevant characteristic of an available resource. When the event arises, the resource selection system selects the appropriate preference policy and applies the specified preferences to each available resource. Administrators may create policies which assign a characteristic preference order of known resource features. The most preferred resource is selected accordingly. However, prior art systems and methods only utilize a static preference order, e.g. “security” may always have priority over “speed” when both are selected according to a given policy.

In view of the foregoing, there is a need for further methods and systems which remove the burden of data storage system selection from the application programmer and storage administrator and which results in improved efficiency and data management. There is also a need for such systems and methods to increase data storage system utilization with automated control wherein the optimum currently available data storage system may be selected based upon an associated set of resource characteristics. There is still further a need for such methods and systems to allowing non-static resource characteristic preference order. These and other needs are met by the present invention as detailed hereafter.

### SUMMARY OF THE INVENTION

Embodiments of the present invention are directed to systems and methods for managing a plurality of computer resources, such as networked storage devices. Each of the plurality of resources may have different characteristics, such as performance, speed, recoverability, availability, security, and/or other parameters. Embodiments of the present invention allow an administrator to assign the characteristic prioritization based on the particular event being processed, such as a network broadcast or e-mail. A weighting function based on the particular event may be defined in a policy and applied to the individual characteristics, e.g. speed and security, of each resource. The available resources are then ranked according to the output of the weighting function and the highest ranking available resource is then selected. Thus, the most appropriate resource is selected based upon the individual identified characteristics of the available resources optimized by the weighted requirements specified in the policy for the particular event.

A typical embodiment of the invention comprises a computer program embodied on a computer readable medium, including program instructions for providing one or more weighting parameters for a weighting function, the one or more weighting parameters being based upon an event, program instructions for applying the one or more weighting parameters by the weighting function to one or more characteristics of each resource of a plurality of available resources to yield a weighted characteristic value for each resource of the plurality of available resources, and program instructions for selecting an optimum resource from the plurality of available resources based on comparing the weighted characteristic value of each of the plurality of available resources. The one or more characteristics of each of the plurality of available resources may meet threshold requirements for the event.

In further embodiments, the optimum resource may correspond to a highest weighted characteristic value of the plurality of available resources. Furthermore, the optimum resource may be selected randomly among all resources having the highest weighted characteristic value of the plurality of available resources in common.

In other embodiments, the weighting function may comprise a weighted value for each existing characteristic of a list of preferred characteristics added together to yield the weighted characteristic value for each resource. The weighted value for each existing characteristic of the list of preferred characteristics may be set in a policy for the event. The weighted value for each existing characteristic of the list of preferred characteristics not set in the policy may be given a zero value. Further, the optimum resource may correspond to a highest weighted characteristic value of the weighted characteristic value for each resource of the plurality of available resources. The policy comprises a security weighted value or a speed weighted value.

Similarly, a typical method embodiment of the invention comprises providing one or more weighting parameters for a weighting function, the one or more weighting parameters being based upon an event, applying the one or more weighting parameters by the weighting function to one or more characteristics of each resource of a plurality of available resources to yield a weighted characteristic value for each resource of the plurality of available resources, and selecting an optimum resource from the plurality of available resources based on comparing the weighted characteristic value of each of the plurality of available resources. Further method embodiments of the invention may be developed consistent with the computer program embodiments.

### BRIEF DESCRIPTION OF THE DRAWINGS

Referring now to the drawings in which like reference numbers represent corresponding parts throughout:

FIG. 1 is a functional block diagram of an exemplary embodiment of the invention;

FIG. 2A illustrates an exemplary computer system that can be used to implement embodiments of the present invention;

FIG. 2B illustrates a typical distributed computer system which may be employed in an typical embodiment of the invention;

FIGS. 3A and 3B illustrate operation of an exemplary embodiment of the invention; and

FIG. 4 is a flowchart of an exemplary method of the invention.

### DETAILED DESCRIPTION OF THE PREFERRED EMBODIMENT

1. Overview

As previously mentioned, embodiments of the present invention are directed to systems and methods for managing a plurality of computer resources, such as networked storage devices. Each of the plurality of resources available on the network may have different characteristics, such as performance, speed, recoverability, availability, security, and/or other parameters. For example, a resource characteristic may be the speed, security, reliability, or other unique aspect of an available resource. Depending upon the particular application (i.e. an event), different resource characteristics may be more important than others. For example, for an event such as a network broadcast, speed may be more important than security. However, for an event such as e-mail, security may take priority over speed.

Embodiments of the present invention allow an administrator to assign the selection prioritization based on the particular event being processed, such as a network broadcast or e-mail. A weighting function based on the particular event may be defined in a policy and applied to the individual characteristics, e.g. speed and security, of each resource. The available resources are then ranked according to the output of the weighting function and the highest ranking available resource is then selected. Thus, the most appropriate resource is selected based upon the individual identified characteristics of the available resources optimized by the weighted requirements specified in the policy for the particular event.

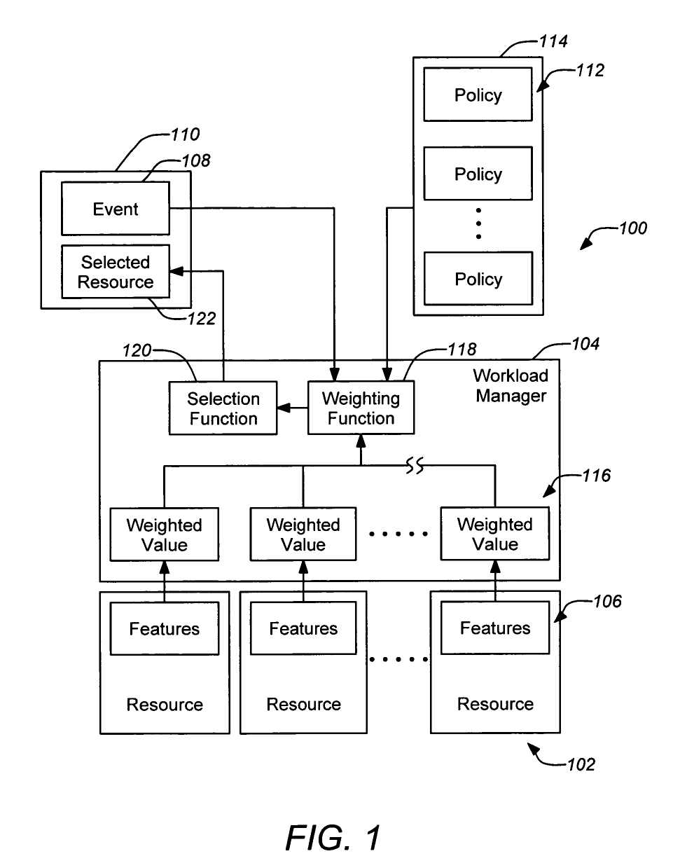

FIG. 1 is a functional block diagram of an exemplary embodiment of the invention. The system 100 allocates usage of a plurality of available resources 102 through the operation of a workload manager 104. Typically, the resources 102 may be storage devices in a networked computer system. Each of the disparate resources 102 may have a different set of characteristics 106 or features. Whereas prior art techniques prioritize selection among the resources 102 according to a static preference order, e.g. selection of a resource having a security characteristic is always given priority over a less secure resource having a speed characteristic, embodiments of the present invention enable resource characteristic according to a dynamic preference order, e.g. different policies invoked by different events define different selection prioritization.

To do this, the workload manager 104 receives an event 108 from a user 110 requesting a resource for a particular application (which may be also be an automated process from a computer). The workload manager 104 then selects the policy 112 corresponding to the event 108 from a library 114 of available policies. A default policy may be applied (which may reside in the manager 114) if the event 108 does not correspond to any of the policies 112 in the library 114. The corresponding policy 112 comprises the weighting parameters which the workload manager 104 will apply according to a weighting function 118 to yield weighted values 116 for each resource 102. The workload manager 104 may optionally prescreen the resources 102 for the presence of particular characteristics 106 which meet threshold requirements for the particular event 108 before applying the weighting function 118. For example, if security is a necessary characteristic of the selected resource for a particular event, it is not necessary to determine weighted values 116 for resources 102 not meeting the necessary threshold security characteristics. The workload manager 104 then performs a selection function 120 among the available resources 102 provided by the weighting function 118 to determine the optimum resource 122 for the particular event 108 and returns that selected resource 122 to the user 110.

In one example, the weighting parameters of the applied policy 112 comprise a value for each desired resource characteristic. Correspondingly larger values are given for more important desired resource characteristics. The weighting function 118 of the workload manager 104 then determines the weighted value 116 for each resource 106 as the sum of the values of the policy for each characteristic that exists for the resource 106 being evaluated. The selection function 120 then selects the resource with the highest sum as the optimum selected resource 122. In some instances, the highest sum may be identical for more than one resource 102. In this case, the selection function may randomly determine the selected resource among the resources 102 having the highest sum in common. Alternately, some other secondary selection function may be performed among the resources 102 having the highest sum in common.

It should be noted that those skilled in the art may develop alternate and/or modified weighting function 118 and selection function 120. However, the invention encompasses such variations provided that prioritization of the available resources 102 changes dynamically based upon differing parameters applied according to the particular event being processed.

In addition, the features and characteristics of the resources can also be dynamic. Resource features such as performance caching can be enabled or disabled while characteristics, such as free space, are continuously changing. Whereas the prior art may define static weighting of resource characteristics, embodiments of the present invention allow dynamic weighting based on assigned policies.

2. Hardware Environment

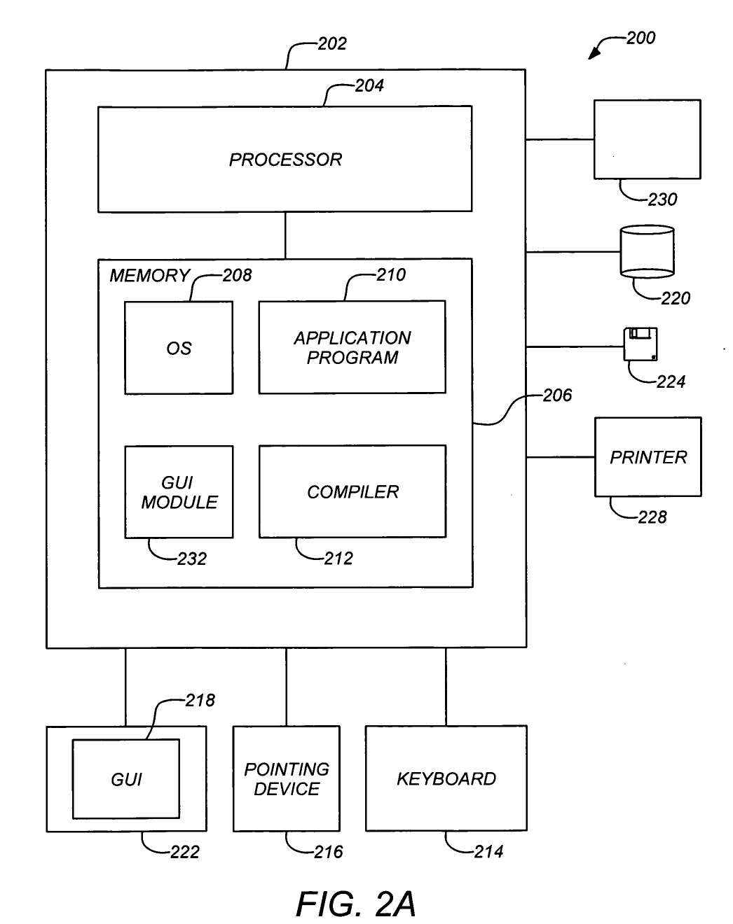

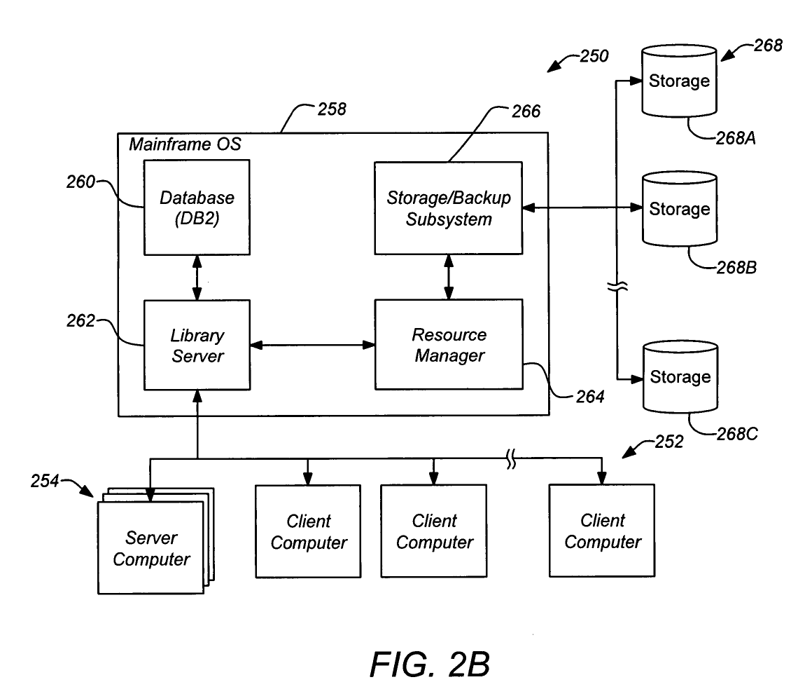

FIG. 2A illustrates an exemplary computer system 200 that can be used to implement embodiments of the present invention. The computer 202 comprises a processor 204 and a memory 206, such as random access memory (RAM). The computer 202 is operatively coupled to a display 222, which presents images such as windows to the user on a graphical user interface 218. The computer 202 may be coupled to other devices, such as a keyboard 214, a mouse device 216, a printer, etc. Of course, those skilled in the art will recognize that any combination of the above components, or any number of different components, peripherals, and other devices, may be used with the computer 202.

Generally, the computer 202 operates under control of an operating system 208 (e.g. z/OS, OS/2, LINUX, UNIX, WINDOWS, MAC OS) stored in the memory 206, and interfaces with the user to accept inputs and commands and to present results, for example through a graphical user interface (GUI) module 232. Although the GUI module 232 is depicted as a separate module, the instructions performing the GUI functions can be resident or distributed in the operating system 208, a computer program 210, or implemented with special purpose memory and processors.

The computer 202 also implements a compiler 212 which allows one or more application programs 210 written in a programming language such as COBOL, PL/1, C, C++, JAVA, ADA, BASIC, VISUAL BASIC or any other programming language to be translated into code that is readable by the processor 204. After completion, the computer program 210 accesses and manipulates data stored in the memory 206 of the computer 202 using the relationships and logic that was generated using the compiler 212. The computer 202 also optionally comprises an external data communication device 230 such as a modem, satellite link, ethernet card, wireless link or other device for communicating with other computers, e.g. via the Internet or other network.

In one embodiment, instructions implementing the operating system 208, the computer program 210, and the compiler 212 are tangibly embodied in a computer-readable medium, e.g., data storage device 220, which may include one or more fixed or removable data storage devices, such as a zip drive, floppy disc 224, hard drive, DVD/CD-rom, digital tape, etc., which are generically represented as the floppy disc 224. Further, the operating system 208 and the computer program 210 comprise instructions which, when read and executed by the computer 202, cause the computer 202 to perform the steps necessary to implement and/or use the present invention. Computer program 210 and/or operating system 208 instructions may also be tangibly embodied in the memory 206 and/or transmitted through or accessed by the data communication device 230. As such, the terms “article of manufacture,” “program storage device” and “computer program product” as may be used herein are intended to encompass a computer program accessible and/or operable from any computer readable device or media.

Embodiments of the present invention are generally directed to any software application program 210 that manages devices over a network, such as storage and backup devices. The program 210 may operate within a single computer 202 or as part of a distributed computer system comprising a network of computing devices. The network may encompass one or more computers connected via a local area network and/or Internet connection (which may be public or secure, e.g. through a VPN connection).

FIG. 2B illustrates a typical distributed computer system 250 which may be employed in an typical embodiment of the invention. Such a system 250 comprises a plurality of computers 202 which are interconnected through respective communication devices 230 in a network 252. The network 252 may be entirely private (such as a local area network within a business facility) or part or all of the network 252 may exist publicly (such as through a virtual private network (VPN) operating on the Internet). Further, one or more of the computers 202 may be specially designed to function as a server or host 254 facilitating a variety of services provided to the remaining client computers 256. In one example one or more hosts may be a mainframe computer 258 where significant processing for the client computers 256 may be performed. The mainframe computer 258 may comprise a database 260 which is coupled to a library server 262 which implements a number of database procedures for other networked computers 202 (servers 254 and/or clients 256). The library server 262 is also coupled to a resource manager 264 which directs data accesses through storage/backup subsystem 266 that facilitates accesses to networked storage devices 268 comprising a SAN (such as shown in FIG. 1). The SAN includes devices such as direct access storage devices (DASD) optical storage and/or tape storage indicated as distinct physical storage devices 268A-268C. Various known access methods (e.g. VSAM, BSAM, QSAM) may function as part of the storage/backup subsystem 266. Notably, embodiments of the present invention may operate as part of or in support of the resource manager 264 to facilitate the selection of optimum resources to meet the needs of the interconnected users. Embodiments of the invention may be implemented in software such as an operating system, or hardware microcode such as a SAN/NAS storage controller or network router which provides resource selection.

Those skilled in the art will recognize many modifications may be made to this hardware environment without departing from the scope of the present invention. For example, those skilled in the art will recognize that any combination of the above components, or any number of different components, peripherals, and other devices, may be used with the present invention meeting the functional requirements to support and implement various embodiments of the invention described herein.

3. Event Based Resource Selection

As previously described, the prior art describes administrators creating policies which assigns a feature preference order of known resource characteristics. Particularly, U.S. Pat. No. 5,018,060, issued May 21, 1991 to Gelb et al. (Gelb), describes the use of administrator policies. Further, U.S. Pat. No. 5,491,810 issued Feb. 13, 1996 to Allen (Allen), describes administrators creating policies which assign a resource characteristic (i.e. feature) preference order of known resource characteristics, such as security, speed and reliability. As will be understood by those skilled in the art, embodiments of the present invention may be readily applied to the teachings of Gelb and Allen to enhance their operation.

In a networked computer system, applications such as public broadcasts may sometimes prefer speed over security, but preferring both over other resource features. In the prior art, there are two typical techniques to prefer the generally lesser weighted speed over the security weighting. One is to specify no preference for security, allowing speed to be the only preference. However, this approach does not prefer secure resources over non-secure resources. Accordingly, the optimal resource may not be selected. A second technique is to specify speed as a required feature. However, this approach may cause requests to fail if a fast resource is unavailable.

Although implementation of the prior art describes a static preference order (e.g. security is more preferred than speed), embodiments of the present invention describe a technique to select between resources of differing characteristics such that a separate resource preference policy can be defined for each event. When the event arises, a workload manager selects the appropriate policy and matches the specified preferences in the policy to each available resource. The most preferred resource is then selected. Thus, embodiments of the present invention allow an administrator to assign the characteristic prioritization based on the particular event being processed. For example, for an event such as a network broadcast, speed may be more important than security. An exemplary embodiment of the invention may be illustrated through a description of the process of event based prioritization of the resources selection as follows.

An event occurs such as new data arriving for storage, or a fault signal needing attention. Selection policies are predefined by the system administrator. A single policy is selected based on the event. A workload manager enforces the selected policy by assigning weighted values of the event policy to each resource characteristic of interest. Thus, if a characteristic is deemed preferred by the admininistrator, a predetermined weight value is assigned. A zero value may be assigned to indicate there is no preference if a characteristic is present for a resource that is not identified in the policy for the particular event. A zero weight value may also be assigned to the resource characteristic if the characteristic (or feature) is requested and not available on the resource. Assigned weighted characteristics are then tabulated for each resource, where each sum represents the particular resource's ability to meet the desired features defined by the applicable policy. The workload manager then selects (e.g. the highest sum) an available resource based on features which best match the assigned policy. If more than one resource has the same features and assigned weighted value, selection may be done randomly or by another workload management policy not described here. A list of the available resources which satisfy all the required features in the assigned policy and associated weighted values are processed by the selection function of the workload manager.

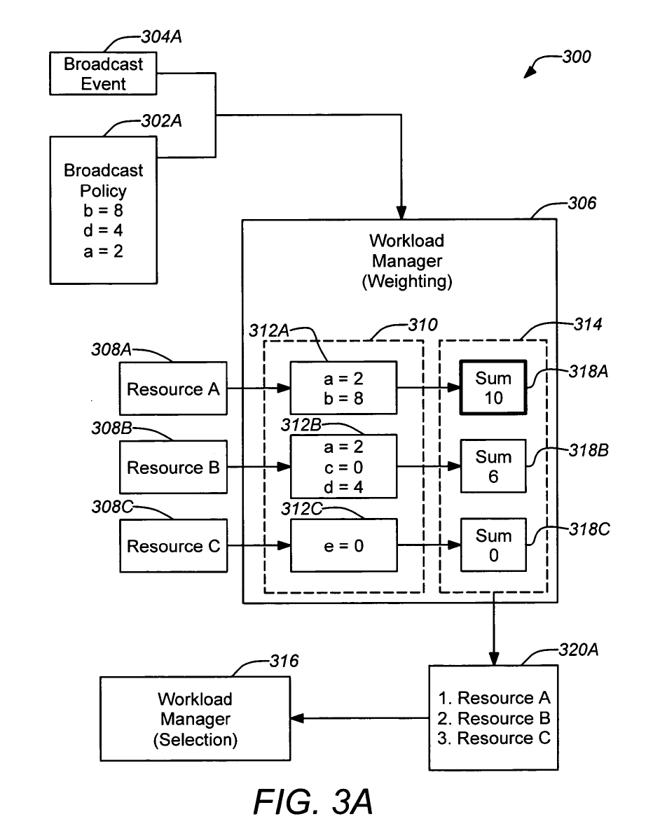

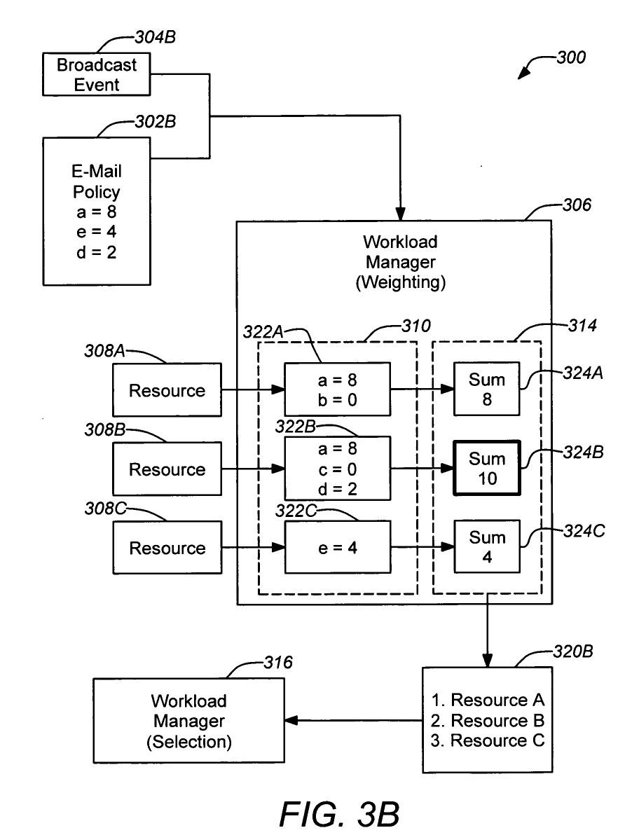

FIGS. 3A and 3B illustrate operation of an exemplary embodiment of the invention. The system 300 employs different policies 302A, 302B set by an administrator to be invoked upon the occurrence of particular events 304A, 304B. The policies 302A, 302B comprise weighting parameters which are used in the selection prioritization process. The weighting parameters may include a weighting value assigned to each important characteristic (or feature) of a potential resource, higher values being given to more important characteristics. The following table is an example list of resource characteristics and static preference values of the prior art IBM system managed storage (SMS) for which embodiments of the invention may be applied as described herein.

| | | Preference |
|---|---|---|
| Characteristic | Preferences | Value |
| VIO | A VIO storage group is made eligible by | 8192 |
| | the storage group ACS routine and the data | |
| | set is capable of VIO. | |
| DATA SET | Volume does not reside in the same | 4096 |
| SEPARATION | physical control unit that has allocated a | |
| | data set from which this data set should be | |
| | separated, as specified in the data set | |
| | separation profile. | |
| VOLUME | Volume resides in a storage group that has | 2048 |
| COUNT | enough eligible volumes to satisfy the | |
| | requested VOLUME COUNT. | |
| HIGH | Volume has sufficient space for the | 1024 |
| THRESHOLD | allocation amount without exceeding the | |
| | storage group HIGH THRESHOLD value. | |
| SMS STATUS | Volume and its associated storage group | 512 |
| | SMS status are ENABLED. | |
| END-OF- | This is an end-of-volume extend, where an | 256 |
| VOLUME | extend storage group is specified, and the | |
| EXTEND | volume does not reside in the specified | |
| | extend storage group. | |
| NON- | Volume resides in a nonoverflow storage | 128 |
| OVERFLOW | group. | |
| IART | Volume is mountable, and an IART value | 64 |
| | greater than zero was specified in the | |
| | storage class. | |
| SNAPSHOT | Volume is in the same SnapShot-capable | 32 |
| | controller as the data set, and this is a snap | |
| | request. | |
| | Volume resides in a control unit that | |
| | supports ACCESSIBILITY, and the | |
| | storage class ACCESSIBILITY value is | |
| | PREFERRED. | |
| ACCESS- | Volume resides in a control unit that does | 16 |
| IBILITY | not support ACCESSIBILITY, and the | |
| | storage class ACCESSIBILITY value is | |
| | STANDARD. | |
| | Volume resides in a control unit that | |
| | supports AVAILABILITY and the storage | |
| | class AVAILABILITY value is | |
| | PREFERRED. | |
| AVAIL- | Volume resides in a control unit that does | 8 |
| ABILITY | not support AVAILABILITY and the | |
| | storage class AVAILABILITY value is | |
| | STANDARD. | |
| EXTENDED | Volume resides in a control unit that | 4 |
| FORMAT | supports EXTENDED FORMAT and the | |
| | data class IF EXT value is PREFERRED. | |
| MILLE- | Volume provides the requested response | 2 |
| SECOND | time that is specified or defaulted in the | |
| RESPONSE | storage class DIRECT MSR or | |
| (MSR) | SEQUENTIAL MSR. | |
| | Volume provides a faster response time | 1 |
| | than what is specified or defaulted in the | |
| | storage class DIRECT MSR or | |
| | SEQUENTIAL MSR. | |

If a characteristic is not requested or not met, its preference value defaults to zero. Through the setting and application of event based policies, embodiments of the present invention may reprioritize the selection preferences of these and/or other resources characteristics to optimize the resource selected for a particular application. To illustrate operation of the present invention, a simplified list of potential characteristics may include (a) secure, (b) short distance, (c) nonoverflow, (d) fast, and (e) recoverable. Operation of the system 300 is described hereafter for a broadcast event 304A and an e-mail event 304B. However, any number of different events having different prioritization of resource characteristics may be set and employed by the system 300.

FIG. 3A illustrates operation of an exemplary embodiment of the invention for a broadcast event 304A. The system 300 begins with a broadcast event 304A received by the workload manager weighting module 306 indicating a need for storage resources to implement a network broadcast. The weighting module 306 invokes the applicable broadcast policy 302A for the broadcast event 304A. Included in the parameters of the broadcast policy 302A are weighting values for particular characteristics of the available resources 308A-308C. In this case, the weighting values comprise a value of 8 for (b) short distance, a value of 4 for (d) fast, and a value of 2 for (a) secure. The weighting module 306 applies the weighting values to the individual characteristics 312A-312C of each available resource 308A-308C by a weighting function 310. The weighting function 310 comprises determining a total of the weighting values for each characteristic present for a particular resource 308A-308C.

The characteristics 312A of resource 308A are (a) secure and (b) short distance, so the weighted characteristic value 318A output from the weighting function 310 is 10 (2 for secure added to 8 for short distance). Similarly, the characteristics 312B of resource 308B are (a) secure, (c) nonoverflow and (d) fast, so the weighted characteristic value 318B output from the weighting function 310 is 6 (2 for secure added to 4 for fast). In this case, the presence of the (c) nonoverflow characteristic in resource 308B is given a default value of zero because it is not identified in the broadcast policy 302A. Finally, the characteristics 312C of resource 308C is only (e) recoverable, so the weighted characteristic value 318C output from the weighting function 310 is 0 (a default value of zero).

Note that the available resources 308A-308C be the result of prescreening a larger group of resources by the weighting module 306 (or some other function) to eliminate all resources not meeting certain minimum necessary threshold characteristic requirements (which may also be identified in the policy). It is not necessary to include these characteristics in the weighting and selection process because all the available resources 308A-308C include these characteristics.

Following operation of the weighting function 310, the workload manager selection module 316 selects the optimum resource for the broadcast event 304A. The selection function 314 operates on the weighted characteristic values 318A-318C of the available resources 308A-308C. In the exemplary embodiment, the selection function 314 operates to determine the highest weighted characteristic value as the optimum resource. In this case, the selection module 316 identifies resource 308A, having the highest weighted characteristic value 318A, as the optimum resource for the broadcast event 304A. A tabulated list 320A of the available resources 308A-308C appropriately prioritized for the broadcast event 304A to the requesting user or system may be returned by the weighting module 306 to the selection module 316. The selection module 316 then delivers each listed resource 308A-308C in the prioritized order to the requesting user or system until the resource need is fulfilled. As previously discussed, a secondary selection process may be employed (e.g. random selection) to resolve a situation where more than one resource has the highest weighted characteristic value in common.

It should also be noted that although the workload manager is shown as two separate elements, the weighting module 306 and the selection module 316 to better illustrate the prioritization process, a unified program embodiment may perform the functions of both modules 306, 316 as will be understood by those skilled in the art; separate modules are possible, but not required.

FIG. 3B illustrates operation of an exemplary embodiment of the invention for an alternate e-mail event 304B. The system 300 operates in the same manner as previously illustrated in FIG. 3A, however, the prioritization is changed due to the different parameters specified in the e-mail policy 302B. Here, the weighting values comprise a value of 8 for (a) secure, a value of 4 for (e) recoverable, and a value of 2 for (d) fast. Thus, the characteristics 322A of resource 308A are (a) secure and (b) short distance, yield the weighted characteristic value 324A output from the weighting function 310 of 8 (8 for secure added to 0 for short distance). Similarly, the characteristics 322B of resource 308B are (a) secure, (c) nonoverflow and (d) fast, so the weighted characteristic value 324B output from the weighting function 310 is 10 (8 for secure added to 2 for fast). Finally, the characteristics 322C of resource 308C is only (e) recoverable, so the weighted characteristic value 324C output from the weighting function 310 is 4.

The selection function 314 now operates on the new weighted characteristic values 324A-324C of the available resources 308A-308C. In this case, the selection module 316 identifies resource 308B, having the highest weighted characteristic value 324B, as the optimum resource for the e-mail event 304B. A tabulated list 320B of the available resources 308A-308C now appropriately prioritized for the e-mail event 304B may be returned by the weighting module 306 to the selection module 316. The selection module 316 then delivers each listed resource 308A-308C in the prioritized order to the requesting user or system until the resource need is fulfilled. As will be understood by those skilled in the art, the foregoing process as illustrated in FIGS. 3A and 3B can be applied to any number of resources having any number of identifiable characteristics.

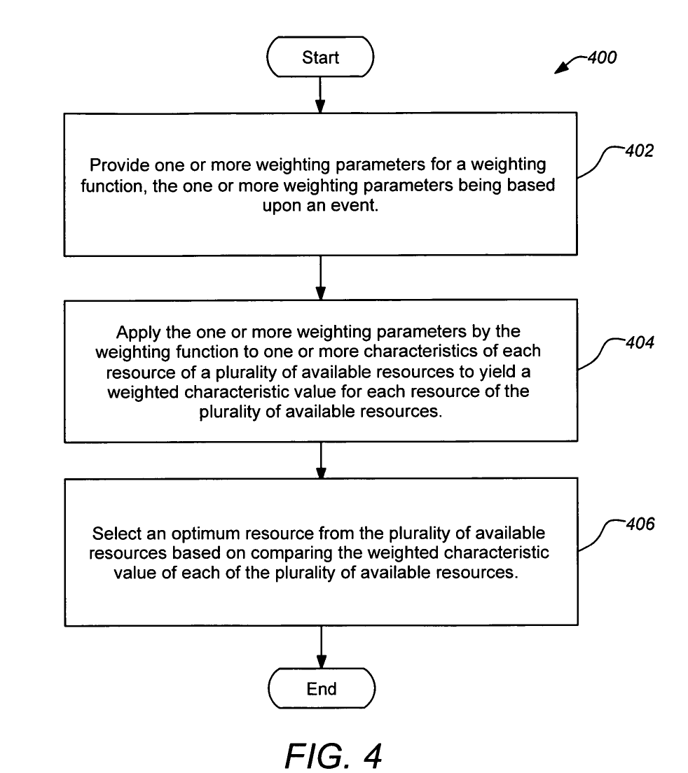

FIG. 4 is a flowchart of an exemplary method 400 of the invention. The method 400 begins with an operation 402 of providing one or more weighting parameters for a weighting function, the one or more weighting parameters being based upon an event. In operation 404, the one or more weighting parameters are applied by the weighting function to one or more characteristics of each resource of a plurality of available resources to yield a weighted characteristic value for each resource of the plurality of available resources. Finally, in operation 406 an optimum resource is selected from the plurality of available resources based on comparing the weighted characteristic value of each of the plurality of available resources. The exemplary method 400 may be further modified consistent with the computer program and system embodiments previously described.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for providing one or more weighting parameters for a weighting function, the one or more weighting parameters being based upon an event;
program instructions for applying the one or more weighting parameters by the weighting function to one or more characteristics of each resource of a plurality of available resources to yield a weighted characteristic value for each resource of the plurality of available resources; and
program instructions for selecting an optimum resource from the plurality of available resources based on comparing the weighted characteristic value of each of the plurality of available resources.

2. The computer program of claim 1, wherein the one or more characteristics of each of the plurality of available resources meet threshold requirements for the event.

3. The computer program of claim 1, wherein the optimum resource corresponds to a highest weighted characteristic value of the plurality of available resources.

4. The computer program of claim 3, wherein the optimum resource is selected randomly among all resources having the highest weighted characteristic value of the plurality of available resources in common.

5. The computer program of claim 1, wherein the weighting function comprises a weighted value for each existing characteristic of a list of preferred characteristics added together to yield the weighted characteristic value for each resource.

6. The computer program of claim 5, wherein the weighted value for each existing characteristic of the list of preferred characteristics is set in a policy for the event.

7. The computer program of claim 6, wherein the weighted value for each existing characteristic of the list of preferred characteristics not set in the policy is given a zero value.

8. The computer program of claim 6, wherein the optimum resource corresponds to a highest weighted characteristic value of the weighted characteristic value for each resource of the plurality of available resources.

9. The computer program of claim 6, wherein the policy comprises a security weighted value.

10. The computer program of claim 6, wherein the policy comprises a speed weighted value.

11. A method, comprising:
providing one or more weighting parameters for a weighting function, the one or more weighting parameters being based upon an event;
applying the one or more weighting parameters by the weighting function to one or more characteristics of each resource of a plurality of available resources to yield a weighted characteristic value for each resource of the plurality of available resources; and
selecting an optimum resource from the plurality of available resources based on comparing the weighted characteristic value of each of the plurality of available resources.

12. The method of claim 11, wherein the one or more characteristics of each of the plurality of available resources meet threshold requirements for the event.

13. The method of claim 11, wherein the optimum resource corresponds to a highest weighted characteristic value of the plurality of available resources.

14. The method of claim 13, wherein the optimum resource is selected randomly among all resources having the highest weighted characteristic value of the plurality of available resources in common.

15. The method of claim 11, wherein the weighting function comprises a weighted value for each existing characteristic of a list of preferred characteristics added together to yield the weighted characteristic value for each resource.

16. The method of claim 15, wherein the weighted value for each existing characteristic of the list of preferred characteristics is set in a policy for the event.

17. The method of claim 16, wherein the weighted value for each existing characteristic of the list of preferred characteristics not set in the policy is given a zero value.

18. The method of claim 16, wherein the optimum resource corresponds to a highest weighted characteristic value of the weighted characteristic value for each resource of the plurality of available resources.

19. The method of claim 16, wherein the policy comprises a security weighted value.

20. The method of claim 16, wherein the policy comprises a speed weighted value.
